(19) United States
(12) Patent Application Publication
(10) Pub. No.: US 2003/0191766 A1
(43) Pub. Date: Oct. 9, 2003

(54) Method and system for associating visual information with textual information

(76) Inventor: Gregory Elin, Montclair, NJ (US)

Correspondence Address: Angelo J Bufalino, Vedder Price Kaufman & Kammholz, 24th Floor, 222 North Lasalle Street, Chicago, IL, 60601, US

(21) Appl. No.: 10/381,393

(22) PCT Filed: Sep. 10, 2002
(86) PCT No.: PCT/US02/28655

(51) Int. Cl. G06F 7/00

(52) U.S. Cl. 707/100

(57) ABSTRACT

A method for associating visual information with textual information including selecting an object from a visual representation; creating a unique identifier associating the selected object with the visual representation; creating meta-data for the selected object, the meta-data including textual information providing an interrelationship between the selected object and the visual representation; and associating the meta-data with the selected object separate from the visual representation. A system for associating visual information with textual information includes at least one processor; and a memory, coupled to the at least one processor, the memory including instructions that when executed by the at least one processor, cause the at least one processor to select an object from a visual representation, create a unique identifier associating the selected object with the visual representation, create meta-data for the selected object, the meta-data including textual information providing an interrelationship between the selected object and the visual representation, and associating the meta-data with the selected object separate from the visual representation.

The present application claims the benefit of U.S. Provisional Application No. 60/318,442, filed Sep. 10, 2001.

### NOTICE OF COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but reserves all copyright rights whatsoever.

### FIELD OF THE INVENTION

The present invention generally relates to the field of visual interpretation and data management and, more particularly, to the associating of visual data with textual data.

### BACKGROUND OF THE INVENTION

Image mapping applications are well known in the art and take the form of, among other things, web page authoring tools, image editing tools, and the like. These tools allow portions of images to be associated with meta-data such as, for example, hyperlinks or descriptive text. These systems, however, have taken several forms each of which is cumbersome in its own way.

Conventional applications require the use of multiple tools to edit visual representations and the meta-data associated with those visual representations. Thus, these applications typically lack at least one tool that can be used to perform all manipulations associated with all of the related data. This makes the process of manipulating visual representations with corresponding meta-data more complex than it needs to be. Similarly, some known applications involve embedding the image within a text document or other “document” container as a separate and distinct object. These applications rely on textual information, layout positioning, arrows, or reference keys to allow a user to understand to which area of a visual representation particular meta-data referred. Thus, a visual representation is always accompanied by visual textual information. These applications create a clumsy display that detracts from the aesthetic value of the visual representations as presented and limit the manipulation and exchange of visual representations and meta-data.

Other conventional applications involve adding text to a visual representation. These applications treat that text as part of the visual representation converting the text to pixel data or as a layer object. Thus, these applications require manipulation of meta-data by tools designed to manage pixel-based data as opposed to text-based data.

Still other conventional applications, such as family and corporate archives, identify individuals visually by associating a visual representation containing that individual with the individual. If the visual representation contains more than one individual, separate visual representations must be generated for each individual or object either during the creation of the visual representation or subsequent the creation of the visual representation. Such redundancy is cumbersome to maintain and inefficient in light of time and ease of access and the memory or space required to manage multiple copies of the same visual representation.

None of the aforementioned and related applications are capable of identifying relationships between particular objects (people, objects, places, events and times) portrayed within a visual representation to objects external to the visual representation or relationships, including multi-dimensional relationships, between objects within a visual representation (e.g. a photograph). Further, none of the aforementioned and related applications are capable of identifying relationships with external objects even where those objects appear in other visual representations. Moreover, none of the aforementioned and related applications addresses cross-relationships to implicit and additional data that is-inherent in certain types of images, such as photographs which implicitly contain time and location data.

### SUMMARY OF THE INVENTION

Briefly stated, the present invention is directed to a method for associating visual information with textual information including selecting an object from a visual representation; creating a unique identifier associating the selected object with the visual representation; creating meta-data for the selected object, the meta-data including textual information providing an interrelationship between the selected object and the visual representation; and associating the meta-data with the selected object separate from the visual representation. A system for associating visual information with textual information includes at least one processor; and a memory, coupled to the at least one processor, the memory including instructions that when executed by the at least one processor, cause the at least one processor to select an object from a visual representation, create a unique identifier associating the selected object with the visual representation, create meta-data for the selected object, the meta-data including textual information providing an interrelationship between the selected object and the visual representation, and associating the relationship data with the selected object external to the visual representation.

The textual information may be stored in, for example, an in-line structured data format such as XML, a database format, name value pairs, or any suitable format known in the art. The textual information is associated with the visual representation or with particular objects appearing within the visual representation. Accordingly, the present invention permits a selection of a portion of the visual representation, which can be selected in such a way as to isolate a particular object within the visual representation, and permitting the creation of an association (e.g. interrelationship) between that selected portion or object and the textual information. Moreover, inherent attributes of the visual representation for example, location, time, event, field of view, depth of field, light quality, photographer, any of which may be associated with the visual representation upon its creation by a suitable device, can be incorporated into the memory storing the meta-data. Using suitable functionality, relationships between various objects of the visual representation can be explicitly defined or inferred from the meta-data, including the textual information, associated with those objects.

Thus, the present invention provides the framework for machine-readable and human-readable data protocols for the maintenance and conveyance of information, both explicit and implicit, regarding a plurality of objects visually represented by the image that is simultaneous to the image and available whenever the image is available.

### BRIEF DESCRIPTION OF THE DRAWINGS

The present invention and the advantages and features provided thereby will be more readily appreciated and understood upon review of the following detailed description of invention, when read in conjunction with the following drawings, where like numerals represent like elements, in which:

FIG. 1 is a visual representation in the form of a digitized image;

FIG. 2 is an image map superimposed on a digitized image;

FIG. 3 is an illustration of the boundaries of the image map of FIG. 2. that define selected objects;

FIG. 4 is an illustration of the boundaries of two person-type selected objects and their respective identifying data;

FIG. 5 is an illustration of the boundaries of one of the person-type selected objects and its respective identifying data from FIG. 4. accompanied by its associated meta-data;

FIG. 6 is an illustration of the boundaries of an item-type selected object, its respective identifying data, and its associated meta-data;

FIG. 7 is an illustration of two selected objects taken from different images representing the same real-world person;

FIG. 8 is an illustration of the relationship between two sets of meta-data relating to the two selected objects of FIG. 7;

FIG. 9 is an illustration of an inference of relationship between two selected objects based on the confirmation of two selected objects representing the same real-world person;

FIG. 10 is a conceptual representation of the database structure for maintaining the data and relationships according to an exemplary embodiment of the present invention;

FIG. 11 is a flow chart illustrating the creation of digitized images, creation of meta-data, and the association of meta-data with the appropriate digitized images;

FIG. 12 is a flow chart illustrating the selection of objects from within a visual representation, creation of meta-data, and the association of meta-data with the appropriate selected objects; and

FIG. 13 is a visual representation of the operations illustrated in FIG. 12.

### DETAILED DESCRIPTION OF THE INVENTION

The present invention provides a method and corresponding system for associating data and meta-data with visual representations, identifying and selecting portions of the visual representations (“selected objects”), and associating another level of data and meta-data (e.g. interrelationship data) with those selected objects. The result is a system that allows for the conveyance of information about people, places, and objects appearing in visual representations. The present invention can be implemented as an out-of-process or in-process code library, a stand-alone interface, a browser-based application, an application embedded within a visual capture device, a physical catalog system, or through any other means known in the art.

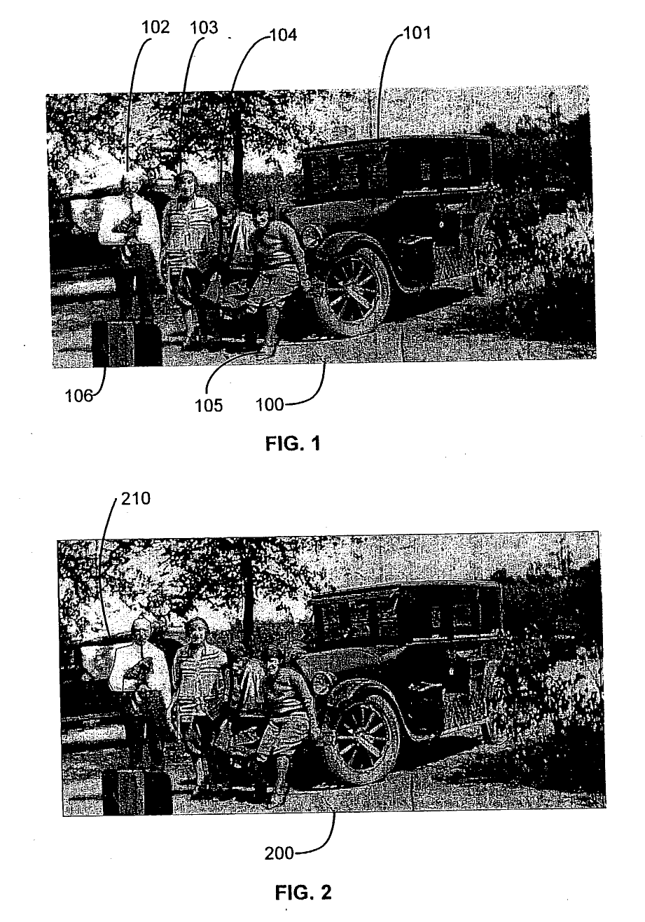

An exemplary embodiment of the present invention, as discussed in greater detail with reference to FIGS. 1-13, is represented by and implemented as a software based application, for example, created using Java, C++, PHP Hypertext Preprocessor (PHP), or any other suitable programming language or combinations thereof that is executed on at least one processor (not shown) or other suitable device, including, but not limited to a microprocessor, microcomputer, digital signal processor, dedicated piece of hardware (e.g. ASIC), state machine or any device that manipulates signals based on operational instructions, a logic circuit or any suitable combination thereof. The software application may be stored in a memory (not shown) coupled to the at least one processor. The memory may include, but is not limited to, a ROM, RAM, floppy disk, distributed memory such as servers on a network, or CD-ROM. A representative system employing the present invention may include the at least one processor, the memory and a suitable display device for providing a graphical user interface with a user.

The present invention may be used to compliment or replace many devices and systems including, but not limited to, the areas of image editing; web development and image mapping; archive and collection management; video editing; family history and genealogy; medical imaging; engineering design; patent application generation; news and media; personal, family, and corporate archiving; wedding documentation; military and civilian law enforcement; education and testing and any other suitable system.

FIG. 1 is a visual representation 100, which is represented as a digital image in .jpg format provided, for example, by a digital camera or acquired from a database, website, or any suitable resource known in the art. The visual representation 100 includes a plurality of objects 101-106 that form the image. For example, the visual representation 100 includes an automobile 101, a group of people 102-105 positioned in front of the automobile 101 and a suitcase 106, positioned relative to the front of one member (e.g. 102) of the group. Images in .jpg format typically include defined flags that identify up to sixteen parsable (e.g. readable and searchable) headers. Each of the headers may maintain different information, for example, flags denoting the beginning or end of data maintained in the headers, the format in which the image data is encoded and how to parse (or read) the headers.

FIG. 2 is an image map 200 relating to the visual representation 100. The image map 200 can be created by any method, for example, software program or algorithm known to those of ordinary skill in the art. An area 210 represents an outline of one of the plurality of objects 101-106 of the visual representation 100 that is selected for annotation and association relative to the visual representation 100 and/or the other objects, according to the present invention. The selection process may be manual, for example, by a user using a mouse (not shown) or other suitable pointing or input device to define or trace an outline 210 of the selected object 102 or by any suitable automated process known to those or ordinary skill in the art.

The object selection process can occur at any point in the processing or displaying of a visual representation, including, but not limited to, while the visual representation 100 (FIG. 1) is being initially created or imported into the system of the present invention. In addition to being manual or automatic, the selection process may be cross-referenced, or algorithmic, which produces incorporated boundaries 210 or other selection of the actual or inferable points, lines, polygonal shapes and visual representation data associated with the complete or partial selected object (e.g. 102) within the image map 200 or across multiple images.

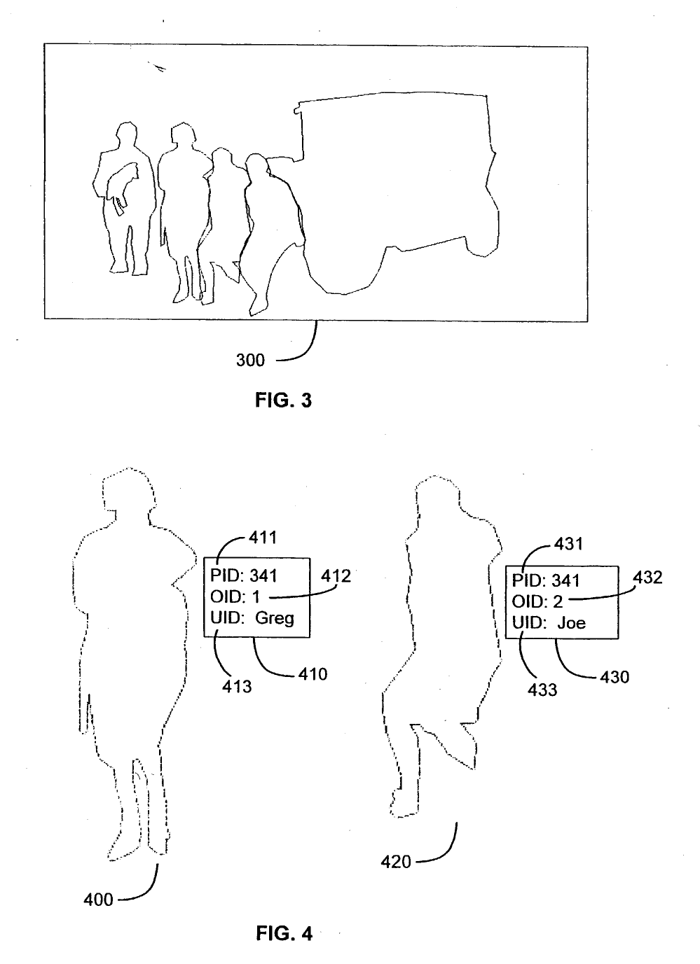

FIG. 3 illustrates the boundaries 300 representing the image map 200 in isolation from the visual representation 100 (FIG. 1) itself. The present invention treats the selection of an object within the visual representation or image map as a new class of object called the selected object, which corresponds to both the selected area of the source visual representation instance and the real-world instance of the selected object. That is, the selected object (e.g. 210 in FIG. 2) is a representation of a real world object appearing in the visual representation 100 (FIG. 1). The selected object can be a single object (e.g. 102 in FIG. 1) or a collection of objects (e.g. a group of people 102-105 in FIG. 1), or an automobile (101 in FIG. 1) or suitable object which itself is composed of several different parts such as tires, a dashboard or other suitable parts).

FIG. 4 illustrates the boundaries of two selected objects 400 and 420 from the visual representation 100 of FIG. 1. Each selected object 400 and 420 has associated with it unique identifying data 410 and 430. The unique identifying data 410, 430 is stored in one of the parsable headers of its corresponding visual representation 100 for subsequent application and use, for example, as a search parameter for an application program. The identifying data 410, 430 represents, for example, database foreign key data 411, 431 for the visual representation in which the selected objects 400 and 420 are found, database primary key data 412, 432 for the selected objects 400 and 420 themselves, and foreign key data 413, 433 for the user who has identified and selected the selected objects 400 and 420. Other identifying data can be captured as is needed. That is, each selected object 400, 420 has a unique identifier 410, 430 assigned either manually or automatically by a suitable algorithm, for example, a Universal Unique Identifier (UUID) generation routine that combines a time stamp with a random number generator or a unique location string. The amount of data stored for the creation of selected objects is not fixed, but can vary according to application and medium or according to the type of object the selected object represents (e.g., person, item, place). For example, it may be necessary to store data for a selected object created from digital video differently than that necessary to store a digitized photograph. This data generally may include, for example, one or more unique identifiers of the source visual representation, coordinate registration information identifying the position of a selected object within the visual representation, scale, creation date, creator information, and any other suitable information.

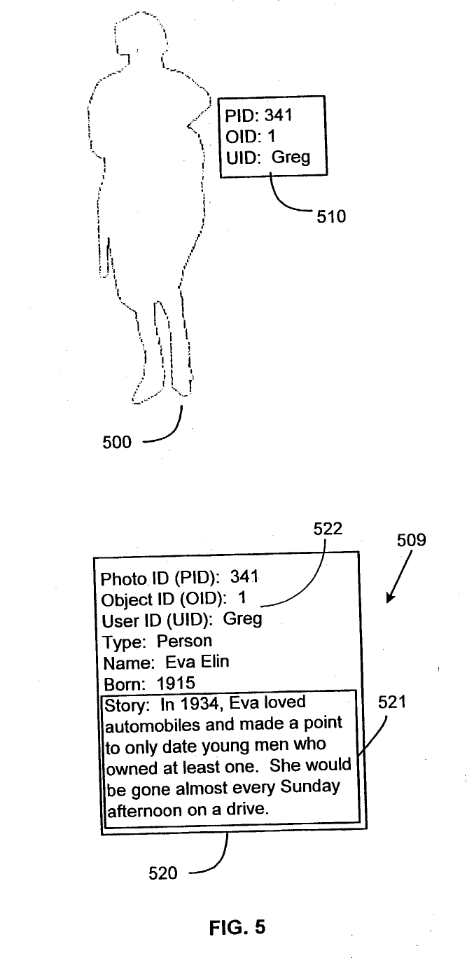

FIG. 5 illustrates the addition of another level of data, meta-data 520, which can be associated with a selected object, for example, 500. The selected object 500 has unique identifying data 510 associated therewith that is maintained in one of the searchable headers of the corresponding visual representation. The selected object 500 represents a person-type object as indicated by the associated meta-data 520. The particular meta-data 520 stored for the selected object 500 is governed in part by the type of the selected object 500. In this example, the selected object 500 represents a person, so the meta-data 520 includes, for example, the persons name and date of birth. Other relevant data, for example, highest educational level attained, associated with the selected object can be captured as well.

The meta-data 520 may include textual information 521 that relates to the specific selected object 500, or about the real-world object the selected object represents. Additionally, the textual information 521 defines or provides an interrelationship between the selected object and the larger visual representation from which it is selected, the selected object and another object within the same visual representation, the selected object and an object within a different visual representation or any combination thereof. The textual information 521 is stored within one or more of the searchable headers of the visual representation for example, in XML format. In this manner, separate memory storage does not have to be used or accessed to maintain or acquire such information as is currently required by conventional applications. Exemplary XML pseudo code for providing the textual information 521 for the selected object 500 is presented below:

IST V 0.1 XML

<selection1>

<oid>1</oid>

<story> In 1934, Eva loved automobiles and made a point to only date young men who owned at least one. She would be gone almost every Sunday afternoon on a drive. </story>

<selectionPolygon>301,150,280, 264 . . . 25,37</selectionPolygon>

</selection1>

where polygon may be, for example, a rectangle, triangle or any suitable primitive or multi-vertex polygon forming the selected object where the values following the selection represent the outline (e.g. vertices) of the object. As will be appreciated and understood by those of ordinary skill in the art, the structure of the stored textual information can vary. For example, instead of XML, textual data can be stored in name value pairs, in a binary format, or a suitable combination thereof. Additional data defining tags can be added and even encased in other tags.

Selected object meta-data can be associated through manual forms or generated through automated means. For example, information previously stored as a preference, information determined by existing meta-data associated with the visual representation, or information inferred from existing meta-data associated with the source visual representation (or other visual representations), may be automatically associated to the meta-data. In application, when a object, for example object 500, is selected from an image (e.g. visual representation 100 (FIG. 1)), a dialog box 509 or other suitable mechanism for receiving and/or displaying textual information 521 is provided on the corresponding display (not shown) separate or isolated from the selected object (e.g. 500) and the visual representation 100 to which the dialog box 509 relates. For purposes of illustration and not limitation, separate means, for example, that the dialog box 509 and the information contained therein is isolated from the selected object and the larger visual representation from which it relates in that the dialog box does not overlay, intersect or share the same area as the selected object or the larger visual representation.

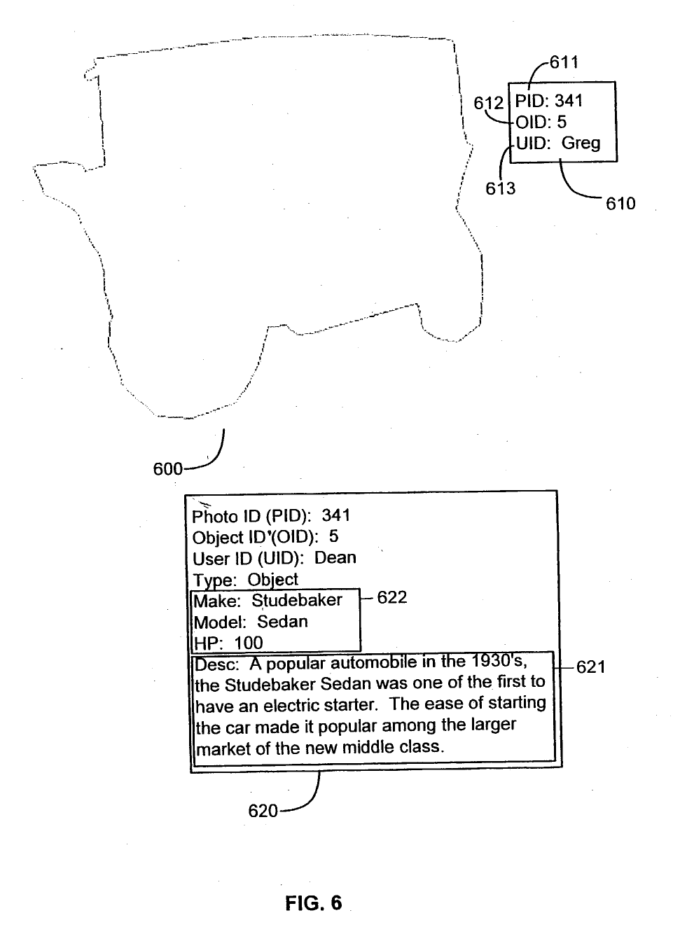

FIG. 6 illustrates the unique identifying data 610 and the meta-data 620 for an item-type selected object 600, in this case an automobile. The unique identifying data 610 includes, for example, the source visual representation 611 of the selected object 600, the primary key data 612 for the selected object 600, and the foreign key data 613 for the user who has identified and selected the selected object 600. For this item-type selected object 600, the meta-data 620 includes secondary primary key data 622 indicating, for example, the make, model, and horsepower of the automobile and textual information 621 providing, for example, historical information relating to the selected object 600 itself. Any other suitable data relevant to the automobile can be captured as well, such as, for example, global positioning system data, or any other relevant data. Furthermore, the type of selected object can be as general as indicated in FIG. 6 or even more specific, such as automobile, building, flower, and any other suitable specific category of real-world objects.

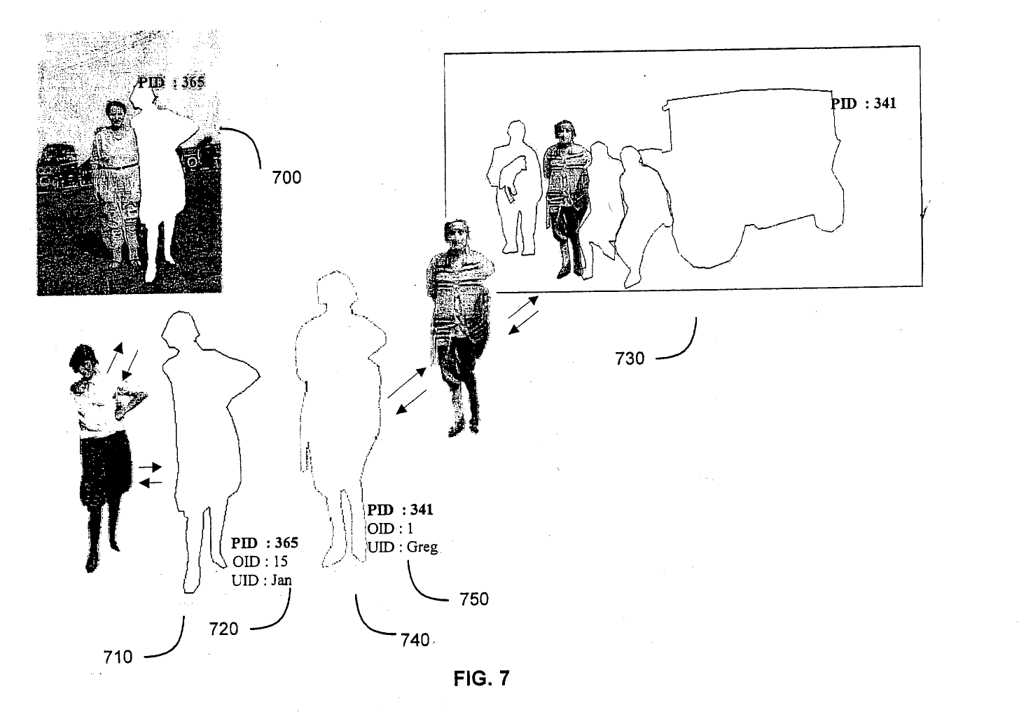

FIG. 7 illustrates two selected objects 710, 740 taken from different visual representations 700, 730, with each selected object representing the same real-world person. Source visual representations can be expanded or “exploded” to display identified selected objects and meta-data associated with selected objects. The manner in which the selected objects, for example 710 and 740, are displayed—randomly, sequentially, on a single page, in a slide-show, in 3-D space—is an example of a process capable of accepting various derived and entered parameters (e.g. unique identifiers 720 and 750). Such process can further be divided into two sub-processes: one that determines what is expanded and how it is expanded, and one that manages the display of the expanded elements. In FIG. 7, the selected objects 710 and 740 are extracted and isolated from their respective source visual representations 700 and 730, and each of the selected objects 710 and 740 are presented with their respective identifying information 720 and 750.

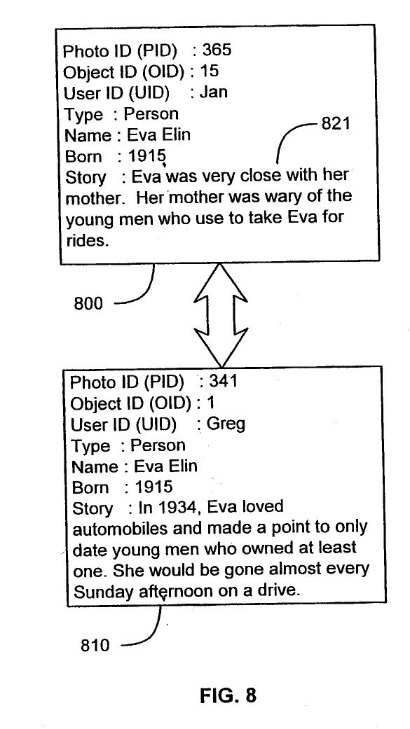

FIG. 8 illustrates the relationship between the meta-data 800 and 810 associated with the selected objects 710 and 740, respectively, shown in FIG. 7. The meta-data 800 and 810 can be examined by any suitable processes, for example, Soundex and/or algorithms, for example, Perl's Algorithm-Diff-1.15 module, to identify information and potential relationships not explicitly entered into the present invention or previously extrapolated from another process. For example, in FIG. 7, the identifying data 720 indicates that selected object 710 has a source visual representation 700 and was entered by a user, Jan. Likewise, the identifying data 750 indicates that selected object 740 has a source visual representation 730 and was entered by a user, Greg. Information (e.g. textual information 821) entered about selected object 710 may also apply to selected object 740 if the selected objects referred to the same real-world object.

The present invention is capable of discovering hidden relationships and meta-data by parsing data that exists at different “levels.” For example, relationship can be inferred from image data, shape data, meta-data on selected objects, meta-data on visual representations, or any other suitable data. The present invention can make inferences either from the cross-referenced data directly or by employing rule sets and artificial intelligence techniques familiar to those of ordinary skill in the art to infer meaning, relationships, and data. The relationship between the meta-data 800 associated with selected object 710 and the meta-data 810 associated with selected object 740 is clear. Meta-data 800 and 810 both refer to a real-world person having the same name and date of birth.

Generally, more subtle and complex relationships are inferred by searching the images (e.g. 700 and 730), and any corresponding database in which such images and associated information are maintained, for commonalities and overlaps. In general, this analytical process may run over an extended period of time of several minutes or several hours for larger archives. A rule set might describe searching for all person-type selected objects that appear together in different source images that were created at significantly different places and points in time; thereby, implying that the two persons knew one another because the two persons appear together repetitively at different locations over an extended time. The associated meta-data, including textual information, for each selected object would then be checked to see if either the other person was mentioned, or some other object was mentioned in which a known relationship existed with the other person. The existence of different types of overlaps would be scored by the rule set for probable meaning or a relationship. A more brute force statistical method might identify all nouns mentioned in different textual information entries and create a nodal map of what object has mentioned another object. The strength of the relationship between nodes would be scored. Then nodes several degrees away from each other might appear to have a relationship, somewhat like the game, “Six Degrees of Separation.”

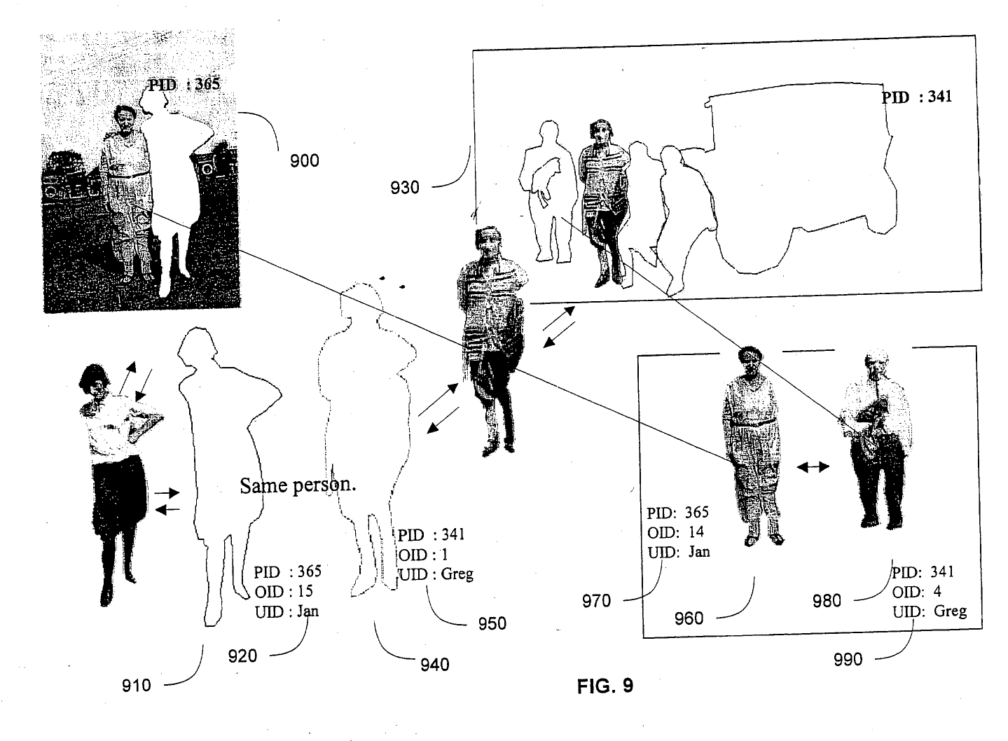

FIG. 9 illustrates this more complicated inference of a relationship between two selected objects 960 and 980 based on meta-data associated with two other selected objects 910 and 940. As discussed above, meta-data (not shown) associated with selected object 910 and the meta-data (not shown) associated with selected object 940 establishes that the selected objects 910 and 940 represent the same real-world person. The identifying data 970 associated with selected object 960 and the identifying data 920 associated with selected object 910 indicates that they have the same source visual representation 900. Similarly, the identifying data 990 associated with selected object 980 and the identifying data 950 associated with selected object 940 indicates that they have the same source visual representation 930. Because the meta-data 800 and 810 (FIG. 8), for example, associated with selected objects 910 and 940 indicate that selected objects 910 and 940 represent the same real-world person, a relationship between selected objects 960 and 980 is inferred. Further analysis of meta-data (not shown) associated with selected objects 960 and 980 can be used to confirm that relationship.

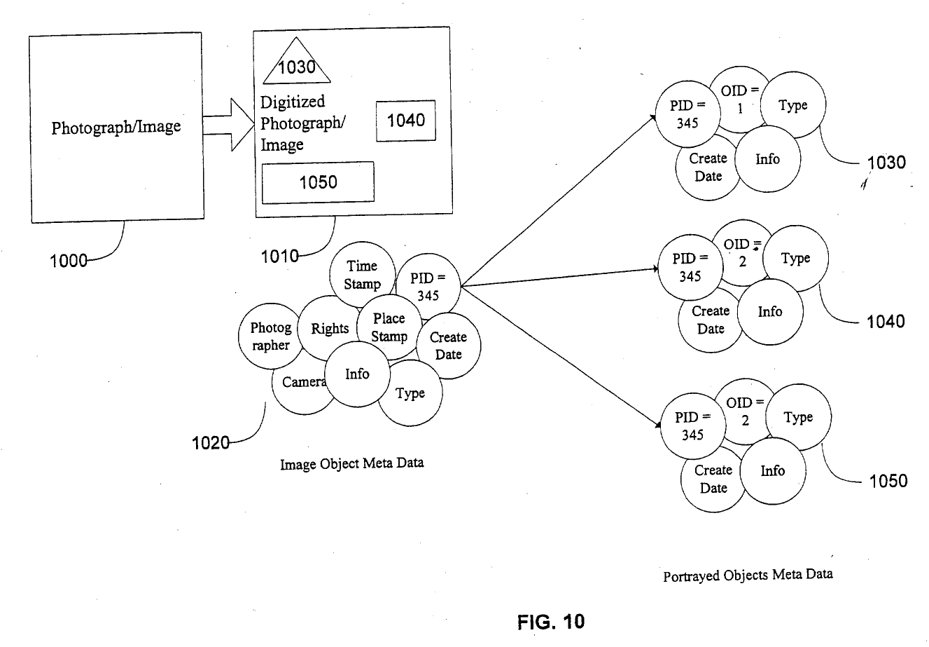

FIG. 10 illustrates an exemplary database structure for maintaining the data and relationships of the present invention. The structure illustrated is that of a relational database, but one of ordinary skill in the art will recognize that other suitable data store formats are available. For example, the present invention can use a flat file format, a record manager format, a non-relational database format, or any other suitable data store format. A visual representation 1000 (in the form of a photograph) is converted to a digitized image 1010. A set of identifying data and meta-data 1020 is associated with the digitized image 1010. Selected objects (not shown) within the digitized image 1010 are identified and selected, and a combination of identifying data and meta-data is associated with each. FIG. 10 illustrates the “parent-child” relationship between the digitized image 1010 and three selected objects implemented through the use of database technology that is well-known in the art. Three sets of identifying data and meta-data 1030, 1040, and 1050 corresponding to three selected objects are associated with the same set of identifying data and meta-data 1020 associated with the digitized image 1010. This is done by assigning a foreign key to the three sets of identifying data and meta-data 1030, 1040, and 1050 corresponding to the primary key of the set of identifying data and meta-data 1020. Thus, each selected object may inherit the identifying data and meta-data 1020 from its “parent” digitized image as well as have its own identifying data and meta-data 1030, 1040, and 1050 associated only with itself.

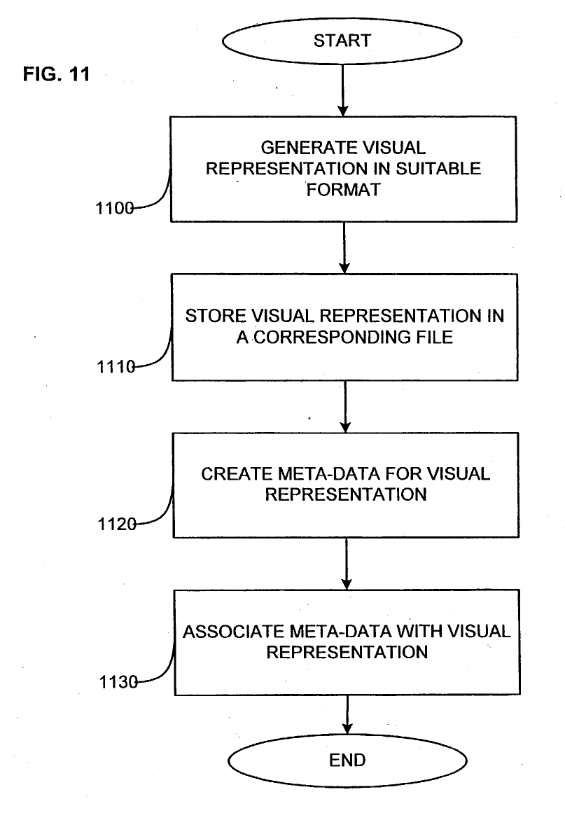

FIG. 11 is a flow chart illustrating the operations performed when creating digitized images, creating the meta-data, and associating the meta-data with the appropriate digitized images. At block 1100, a visual representation of a suitable format for use with the present invention is generated, for example, using techniques known to those of ordinary skill in the art. Exemplary techniques may include, but are not limited to, digital cameras, video capture devices, optical scanners, and any other suitable visual capture devices well known in the art.

At block 1110, the resulting visual representation is stored in a corresponding file on a system (not shown) on which the present invention resides. The visual representation can be stored in a graphics file in *.jpg, *.gif, *.tif, or any one of a number of suitable graphics formats; a video file in *.mpeg or any one of a number of suitable video formats; or any other suitable visual format well known in the art. The system where the visual representation file is stored may include but not be limited to, a personal computer, a mainframe, readable and writeable media, or any other suitable system known in the art. Visual representation and corresponding information can optionally be stored directly or additionally in a relational database thereby providing further performance efficiencies, particularly when managing larger archives of images.

At block 1120, meta-data, including the textual information (e.g. 621 in FIG. 6) is created. Such data also can be created manually, automatically by the visual capture device, automatically by a database management system, or by any other technique well known in the art.

At block 1130, the meta-data is associated with the visual representation, for example, by storing or modifying the meta-data in the header portion of the file containing the visual representation or modifying an associated database entry for the visual representation.

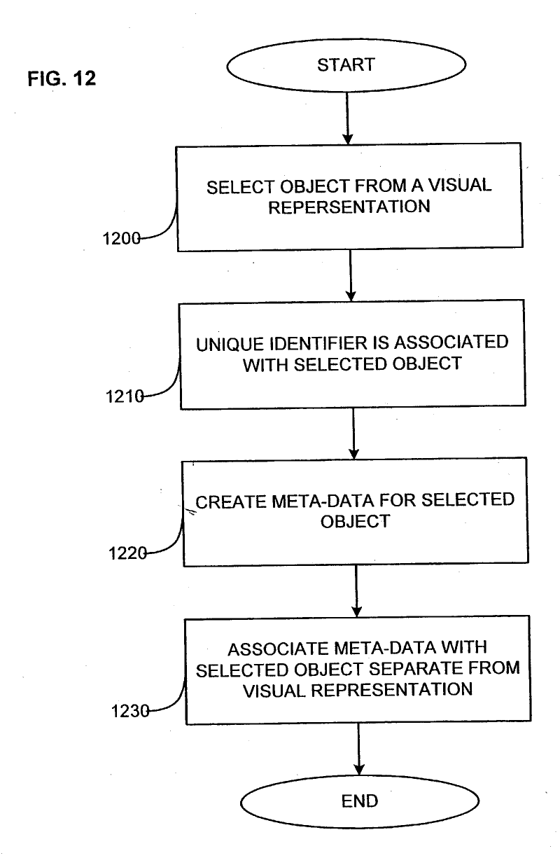

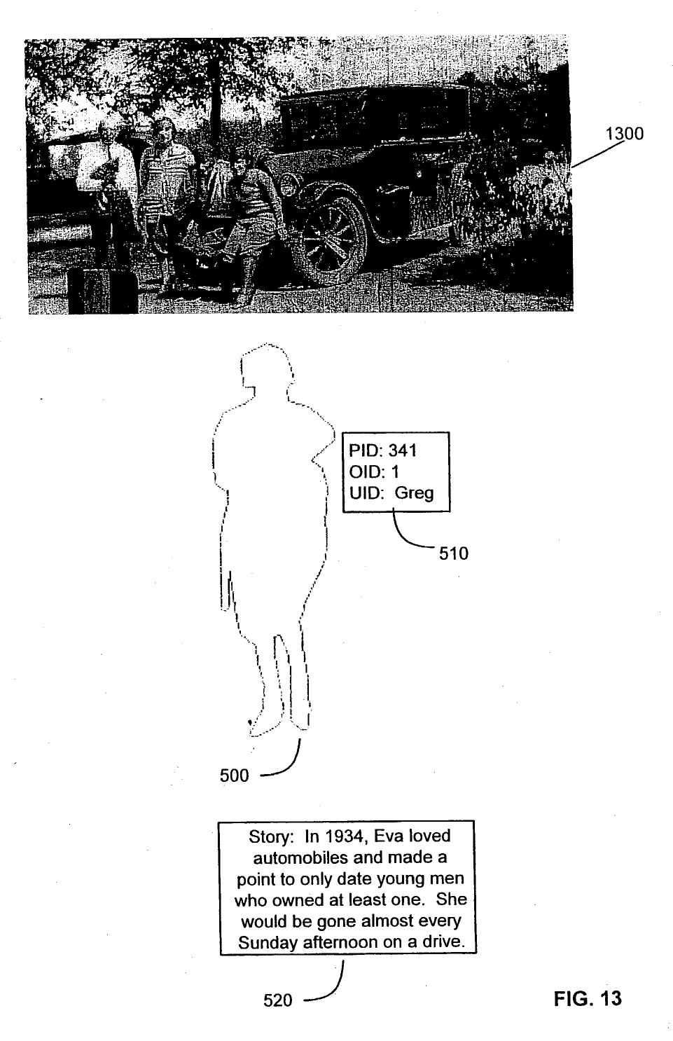

The object selection and interrelation operations performed by the present invention will be discussed with reference to FIGS. 12 and 13. FIG. 12. is a flow chart illustrating the selection of objects within a visual representation 1300 (FIG. 13), for example, a digitized image, creation of meta-data, and the association of meta-data with the appropriate selected objects. FIG. 13 is a visual representation of the operations illustrated in FIG. 12.

At block 1200, using image-mapping techniques well known to those of ordinary skill in the art, for example, using a mouse or other suitable pointing or input device to define or capture an image, an object 500 is selected from within the visual representation 1300. In an exemplary embodiment, the data describing the image map is packaged along with associated meta data and stored within defined flags within the image file headers. A relational database model (FIG. 10) may be employed such that the selected object database entry resides in a selected objects table, which is distinct from the table that holds visual representation entries.

At block 1210, the entry, including the unique identifier 510, for the selected object 510 is associated with the header entry for the visual representation from which the selected object was derived. For purposes of illustration and description, the box including the unique identifier 510 is illustrated in FIG. 13; however, in application, the box may not appear on the display. The association is accomplished, for example, by way of the assignment to the selected object entry of a foreign key indicating the unique identifier (FIG. 6) of the associated visual representation entry. In this manner, the relationship between the selected objects table and the visual representations table is that of a child to a parent, as those terms are commonly understood in the art.

At block 1220, meta-data 520, including textual information 521 is created for the selected object 500. Such meta-data also can be created manually by a user, automatically by the visual capture device, automatically by a database management system, or by any other technique well known in the art. As illustrated in FIG. 13, the meta-data 520 is created (or received) separate from (e.g. below) the selected object 500 to which it relates.

At block 1230, the meta-data 520 is associated with the selected object 500, for example, by adding, modifying or updating the XML data maintained in the searchable headers of the image file that includes the visual representation. In application, such association is visually performed separate from the selected object 500 or larger visual representation 1300 from which the selected object 500 was obtained. Thus, upon completion of the aforementioned example, the present invention can produce a story board having separate components where a selected object or series of objects from within a larger image is annotated to provide information relating to, for example, the selected object or series of objects themselves or the interrelationship between the selected object or series of selected objects and the larger image (e.g. visual representation) from which it was selected.

Based on the foregoing, it will be apparent that the present invention makes advances in the area of visual technology and data management technology. Textual information, structured or unstructured, is associated with the visual representation or with particular objects appearing within the visual representation. This provides the ability to treat visual representations as collections of recognizable objects to which meta-data can be independently as well as hierarchically associated, cross-referenced and searched. Relationships can be inferred and managed between selected objects within the same or different visual representations by an analysis of the combination of the textual information associated with the selected objects, the textual information associated with the visual representations, and the visual data as is well known in the art (i.e., image recognition technology). This is a great improvement over existing tools which lack the ability to support, among other things, a conceptual model for the ongoing integrated conveyance, management and extension of information about both the images and the objects visually represented in the image.

Thus, the present invention provides the framework for machine-readable and human-readable data protocols for the maintenance and conveyance of information, both explicit and implicit, regarding a plurality of objects visually represented by the image that is simultaneous to the image and available whenever the image is available. A significant benefit provided by the present invention is that it treats a visual representation (e.g. photograph) inherently as a collection or database of objects and creates the digital equivalent of persons pointing and telling and sharing stories about items to which the visual representation or underlying image represents or refers.

It should be understood that the implementation of other variations and modifications of the invention in its various aspects will be apparent to those of ordinary skill in the art, and that the invention is not limited by the specific embodiments described. The present invention can take the form of a software application, a physical catalog system of photographs and text entries, or any other suitable device well known in the art. It is therefore contemplated to cover by the present invention, and any and all modifications, variations, or equivalents that fall within the spirit and scope of the basic underlying principles and claimed herein.

What is claimed is:

1. A method for associating visual information with textual information comprising:
selecting an object from a visual representation;
creating a unique identifier associating the selected object with the visual representation;
creating meta-data for the selected object, the meta-data including textual information providing an interrelationship between the selected object and the visual representation; and
associating the meta-data with the selected object separate from the visual representation.

2. The method of claim 1, further comprising displaying the textual information separate from the visual representation.

3. The method of claim 1, wherein the visual representation is maintained in an image file including a plurality of searchable headers, the unique identifier of a selected object being maintained in one of the plurality of searchable headers.

4. The method of claim 3, further comprising maintaining the meta-data in one of the plurality of searchable headers.

5. The method of claim 1, wherein the meta-data further includes identifying unique to the selected object.

6. The method of claim 4, wherein the meta-data is searchable.

7. The method of claim 6, further including searching the meta-data for determining interrelationships between selected objects from different visual representations.

8. The method of claim 6, further comprising searching the meta-data for determining interrelationships between selected objects within the visual representation.

9. The method of claim 4, wherein storing the meta-data further comprises modifying the corresponding header entry of the selected object.

10. A method for associating visual information with textual information, comprising:
retrieving a visual representation;
receiving data identifying a selected object from the visual representation;
receiving textual information interrelating the selected object and the visual representation isolated from the visual representation; and
associating the textual information with the selected object wherein the textual information is within a file containing the selected object.

11. The method of claim 10, further comprising displaying the textual information separate from the visual representation.

12. The method of claim 10, wherein the selected object is identified by defining an outline about a corresponding portion of the image.

13. The method of claim 10, wherein the visual representation is an image including a plurality of objects.

14. The method of claim 10, further comprising linking the textual information to the selected object.

15. The method of claim 10, wherein the textual information includes data identifying the visual representation that is the source of the selected object.

16. A system for associating visual information with textural information, comprising:
at least one processor; and
a memory, coupled to the at least one processor, the memory including instructions that, when executed by the at least one processor, cause the at least one processor to:
select an object from a visual representation;
create a unique identifier associating the selected object with the visual representation,
create meta-data for the selected object, the meta-data including textual information providing an interrelationship between the selected object and the visual representation; and
associating the meta-data with the selected object separate from the visual representation.

17. The system of claim 16, further including a display device operative to display the meta-data separated from the visual representation.

18. The system of claim 16, wherein the instructions cause the at least one processor to store the visual representation in a first portion of the memory and store the unique identifier of the selected object in a second portion of the memory distinct from the visual representation.

19. The system of claim 18, wherein the instructions cause the at least one processor to store the meta-data in the memory such that the meta-data modifies the portion of the memory storing the selected object.
